(19) United States
(12) Patent Application Publication
(10) Pub. No.: US 2020/0189494 A1
(43) Pub. Date: Jun. 18, 2020

(54) LANDING GEAR STRUCTURE WITH HARNESS

(71) Applicant: Safran Landing Systems Canada Inc., Ajax (CA)

(72) Inventors: Joseph Lan, Ajax (CA); Ryan Tam, Ajax (CA)

(73) Assignee: Safran Landing Systems Canada Inc., Ajax (CA)

(21) Appl. No.: 16/219,499

(22) Filed: Dec. 13, 2018

(51) Int. Cl. B60R 16/02; H02G 3/04

(52) U.S. Cl. CPC B60R 16/0207; B33Y 80/00; H02G 3/045

(57) ABSTRACT

A structural component, or parts thereof, for a machine system or vehicle, such as an aircraft, is provided. In some examples, the structural component includes at least one embedded passageway or line. In other examples, the passageway or line is formed integrally on the exterior surface of the structural component. In some of these examples, the structural component can benefit from additive manufacturing techniques or methodologies.

### BACKGROUND

Many systems are provided aboard vehicles, such as aircraft, that consist of moving mobile parts. Wing elements, (for example, an aileron, a flap, an air brake, etc.), elements of the thrust reversers, elements of a propeller pitch driving mechanism, (for example, on an helicopter or a turboprop engine), etc., are just a few of such mobile parts.

Mobile parts are associated with other aircraft systems. For example, most aircraft are equipped with landing gear that enables the aircraft to travel on the ground during takeoff, landing, and taxiing phases. This landing gear comprises several wheels which may be arranged according to configurations varying from one aircraft to the other. These wheels can be braked via movement of a plunger that slides relative to brake friction members. Further, some landing gear may be retracted inside the wings or the fuselage of the aircraft to decrease air drag on the aircraft during flight phases. In these systems, a landing gear strut, for example, is movable between an extended position and a retracted position.

Actuators are commonly used to affect movement of these mobile parts. Generally, an actuator is a mechanical device for moving or controlling components of a mechanism or system. Actuators receive energy and convert the energy into the mechanical motion of an actuator member. For example, the actuator member may be able to move between an extended position and a retracted position. The energy may be transmitted to the actuator member through the use of pressurized liquids (i.e. hydraulics) or pressurized gases (i.e., pneumatics) so that the actuator member moves in response to the pressure changes in the liquid/gas. Alternatively, or additionally, the energy may be transmitted to the actuator member electrically or through other known means of transmitting energy. The energy transmission and the resulting movement of the mechanisms of the actuator, (e.g., the movement of the actuator member), may be controlled remotely or locally, and may be manually or automatically operated.

On modern aircraft, electromechanical actuators are being used to implement such mobile parts. In fact, the advantages of using electromechanical actuators are numerous: simple electric distribution and driving, flexibility, simplified maintenance operations, etc. Generally, an electromechanical actuator comprises a mobile actuating member which moves the mobile part, an electric motor intended to drive the mobile actuating member, and thus the mobile part, and one or more sensor(s) for sensing various parameters of the electromechanical actuator.

These actuators, whether hydraulic/pneumatic, electromechanical, or otherwise, require lines for energy transmission and signal transmission, (e.g., control signal transmission, feedback signal transmission, etc.). These lines are typically arranged in what is called a harness. Current harnesses in aircraft are externally mounted, via brackets, to a structure component a spaced distance from another structure component.

This current design on aircraft adds weight, increases costs, and is vulnerable to damage from bird strikes, etc.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with an aspect of the present disclosure, a solid freeform fabricated structure component is provided. The structure component comprises a body having a first end and a second end, one or more passageways extending through at least a section of the body, and at least one attachment interface positioned near the first end.

In some embodiments, the body has a plurality of exterior surfaces, wherein at least one of the exterior surfaces is constructed of or plated with a metal material.

In some embodiments, the one or more passageways define a plurality of interior surfaces, wherein at least one of the interior surfaces is constructed of or plated with an anti-fiction coating.

In some embodiments, the body includes an integral attachment interface at the second end.

In some embodiments, the structure component further comprises at least one electrical wire routed through one passageway of the one or more passageways.

In some embodiments, the at least one electrical wire is selected from a group consisting of a power wire configured to carry a power signal, a sensor wire configured to carry a sensed signal, and a control wire configured to carry a control signal.

In some embodiments, the one or more passageways includes two or more passageways, and wherein the at least one electrical wire is two or more electrical wires routed through respective passageways of the two or more passageways.

In some embodiments, the one or more passageways includes more than two passageways, the at least one electrical wire is two electrical wires routed through two passageways, respectively, of the more than two passageways, and any remaining passageways is adapted to be connected to a source of pressurized fluid.

In some embodiments, the one or more passageways is connected to a manifold at each end of the passageway, wherein at least one manifold is configured to connect to a source of pressurized fluid.

In accordance with another aspect of the present disclosure, a method is provided for making a structural component having one or more transmission lines. The method comprises obtaining digital data representative of the one or more transmission lines; and using the digital data to fabricate the structural component at least in part by a solid freeform fabrication process.

In some embodiments, the solid freeform fabrication process is selected from the group consisting of direct metal laser sintering (DMLS), selective laser sintering (SLS), electron beam melting (EBM), electron beam freeform fabrication (EBMM), and fused filament fabrication.

In some embodiments, the one or more transmission lines includes two or more pressurized fluid transmission lines.

In some of these embodiments, the method further comprises routing an electrical transmission wire through at least one of the transmission lines.

In some embodiments, the one or more transmission lines includes at least one electrical signal transmission line.

In some of these embodiments, the electrical signal transmission line is formed layer by layer onto an exterior surface of a base component. Additionally or alternatively, the electrical signal transmission line can be formed layer by layer onto an exterior surface of a base component with a dielectric material and a conductive material.

In some embodiments, the method further comprises obtaining digital data representative of a body that includes the one or more transmission lines located within the body.

In some embodiments, the method further comprises plating at least one of the transmission lines with an anti-friction coating.

In some of these embodiments, the digital data is further representative of at least one attachment structure.

In accordance with yet another aspect of the present disclosure, a computer readable medium having a computer executable component comprising CAD data to enable the fabrication of structural component set forth in claims 1-9 or carry out the methods of claims 10-19.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIGS. 1A and 1B are perspective views of one representative embodiment of a structural component of a vehicle or machine system, formed in accordance with one or more aspects of the present disclosure;

FIG. 2 is a partial cut-away view of the structural component shown in FIG. 1A;

FIG. 3 is a cross-sectional view of the structural component of FIG. 1A taken along lines 3-3 in FIG. 1A;

FIG. 4 is a cross-sectional view of the structural component of FIG. 1A taken along lines 4-4 in FIG. 1A;

FIG. 5 depicts a partial cut-away view of another representative embodiment of a structural component of a vehicle or machine system, formed in accordance with one or more aspects of the present disclosure;

FIG. 6 depicts a partial cut-away view of still another structural component of a vehicle or machine system, formed in accordance with one or more aspects of the present disclosure;

FIG. 7 depicts a partial cut-away view of yet another structural component of a vehicle or machine system, formed in accordance with one or more aspects of the present disclosure;

FIG. 8 is a flow chart depicting a representative example of a method for forming a structural component, such as the structural component shown in FIGS. 1-5, in accordance with one or more aspects of the present disclosure;

FIG. 9 is a flow chart depicting a representative example of a method for forming a structural component, such as the structural component shown in FIGS. 6 and 7, in accordance with one or more aspects of the present disclosure; and

FIG. 10 is a block diagram depicting one example of an environment for carrying out the method of FIGS. 8 and 9.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The following description provides several examples that relate to structural components, or parts thereof, for a machine system or vehicle, such as an aircraft. As used herein, a structural member or structural component means any part that is designed specifically for the purposes of carrying, supporting or transmitting a load. Examples of a structural component may include but are not limited to a shock strut, a main fitting, trailing arms, a truck beam, actuators, side and drag braces, etc. In some embodiments, the structural component includes one or more embedded passageways or lines. In other embodiments, the one or more passageways or lines are formed integrally on the exterior surface of the structural components. The one or more passageways or lines can be referred to in some embodiments as a harness.

In some embodiments, these structural components can benefit from additive manufacturing techniques or methodologies. In these examples, the structural components, or parts thereof, can have non-standard shapes and sizes, internal structures, etc. Some embodiments of the present disclosure may be suitably manufactured with any powder bed or direct deposition technology using the melting of rods/wire/powder, such as selective laser sintering (SLS), selective laser melting (SLM®), electron beam melting (EBM), or electron beam freeform fabrication (EBMM), sometimes referred to as electron beam additive manufacturing (EBAM®). Other solid freeform fabrication (SFF) technology, such as fused filament fabrication (FFF), sometimes referred to as fused deposition modeling (FDM®), etc., can be employed to manufacturer one or more structural components of the present disclosure or parts thereof. In some embodiments, the representative methods include optional post-machining, post-treatments, etc.

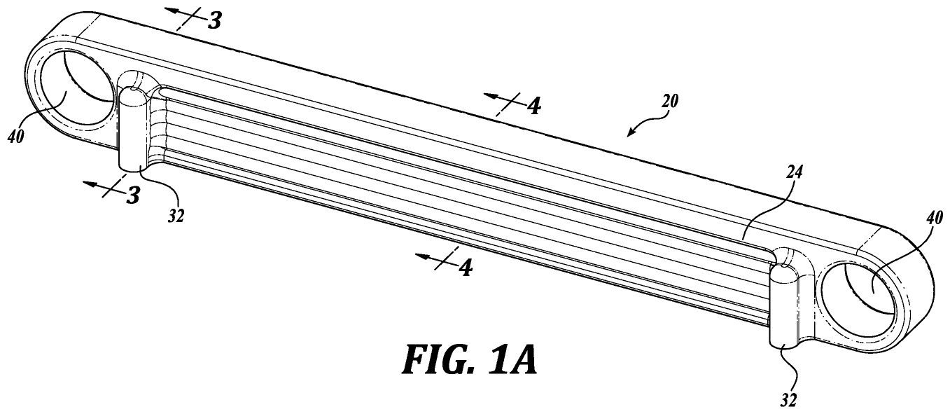

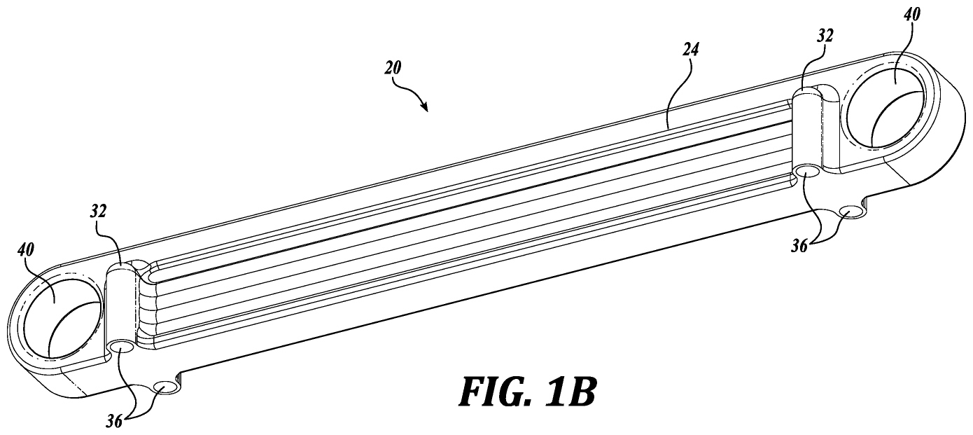

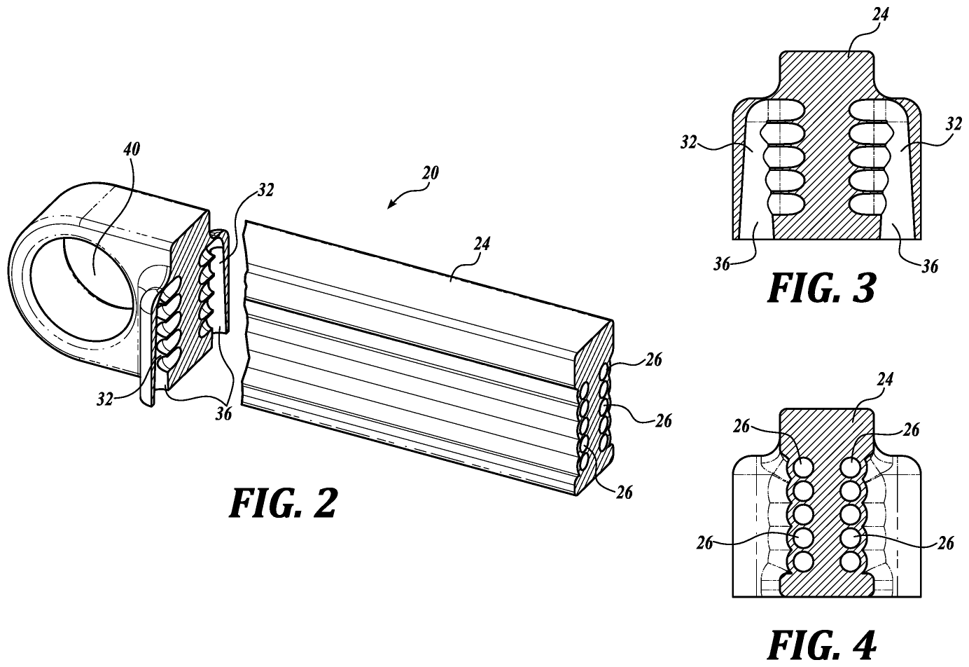

Turning now to FIGS. 1A and 1B, there is shown one representative embodiment of a structural component 20, suitable for use in a vehicle, machine system, or the like, and formed in accordance with one or more aspects of the present disclosure. As shown in FIGS. 1A, 1B, and 2, the structural component 20 includes a lumenal component body 24. In other words, the structural component 20 includes or is formed with one or more lumens or passageways 26, also referred to herein as lines. The structural component 20 in some embodiments is rigid and extends a predetermined length.

The structural component 20, or parts thereof, can have any shape, cross-section or configuration, which will depend on its intended application. For example, the structural component can include any number of passageways 26 (e.g., 1-N). Each passageway can have any cross-sectional shape and can extend the entirety of the structural component 20 or sections thereof. The shape, cross-section and/or configuration of the structural component 20 can be constant along its length or sections thereof. In other embodiments, the shape, cross-section and/or configuration of the structural component can vary along its length or sections thereof.

In some embodiments, the structural component 20 can extend in a linear manner along its predetermined length, as shown in FIG. 1. In other embodiments, the structural component 20 can extend in a non-linear manner along its predetermined length or sections thereof.

In the embodiment shown in FIG. 1A, 1B, and 2-5, the lines or passageways 26 terminate at both ends in manifolds 32, which fluidly connect the lines 26 to one or more inlet/outlet ports 36. In other embodiments, the manifolds 32 can be omitted at one or both ends of the structural component 20, and each passageway or line 26 can originate/terminate at a respective port.

In some embodiments, the structural component 20 can include or be integrally formed with an attachment interface 40, as shown in FIG. 2. Other embodiments are possible. For example, the structural component may include an attachment interface 40 on one type at one end and an attachment interface of another type at the other end for attachment to another structural component or the like.

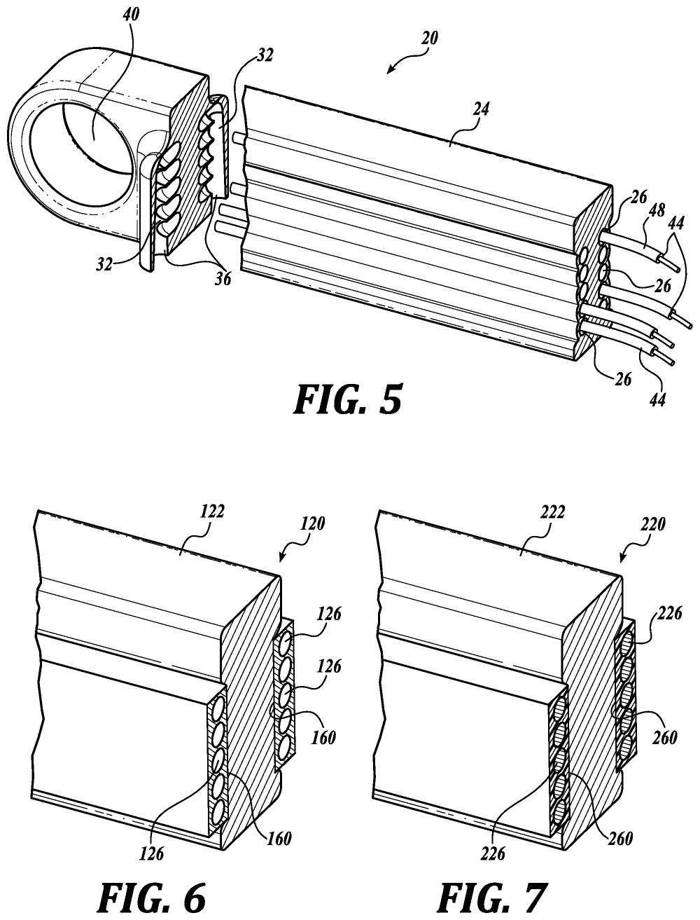

The embodiment shown in FIGS. 1A, 1B, and 2-4 can be employed for hydraulic/pneumatic actuation. In that regard, the lines 26 can be used to route pressurized liquid/gas through the structural component 20 or parts thereof. The structural component 20 of FIGS. 1A, 1B, and 2-4 can also be provided with electrical lines. In that regard, FIG. 5 illustrates the structural member 20 of FIG. 2 with a number of electrical wires 44 routed through the passageways 26. In some embodiments, the electrical wires 44 can be configured for carrying electrical power to, for example, an electrical motor (not shown), can be configured to carry sensor signals, such as position signals, can be configured to carry temperature signals from another electrical component, such as a thermocouple, or the like, and/or can be configured to carry control signals, etc. In embodiments that omit the manifolds 32, the lines or passageways 26 can be used for hydraulic/pneumatic actuation and/or for routing electrical wires 44 therethrough.

In some embodiments, the surfaces of the passageways 26 can be plated, coated, or otherwise formed with an anti-friction material, such as PTFE, to improve routing of the electrical wire 44 through the passageways 26 after fabrication of the structural component 20, and to mitigate any vibration effects of wires fretting against the inside of the structural component 20. Additionally or alternatively, the electrical wires 44 in some embodiments can be single or double shielded wires, and may include in these or other embodiments an anti-friction braided jacket. In embodiments where the structural component 20 is constructed out of a conductive material, the electrical wires can include an insulating jacket 48 or a layer of dielectric material. For some applications, the jacket 48 can have other properties, such as protection against electromagnetic interference (EMI) and/or high intensity radiated fields (HIRF).

FIG. 6 depicts another embodiment of a structure component 120 formed in accordance with one or more aspects of the present disclosure. The structure component 120 is substantially identical to the structure component 20, except for the differences that will now be described in more detail. In some applications where the structural integrity of the structural component cannot be altered, the passageway or lines for hydraulic/pneumatic/electrical actuation can formed on one or more exterior surfaces of the structural component, as shown in FIG. 6. In some embodiments, one or more passageways or lines 126 are plated, coating, or otherwise formed on the external surface 160 of a conventional structure component 122.

FIG. 7 depicts another embodiment of a structure component 220 formed in accordance with one or more aspects of the present disclosure. The structure component 220 is substantially identical to the structure component 20, except for the differences that will now be described in more detail. Again, in some applications where the structural integrity of the structural component cannot be altered, the lines for electrical actuation can be formed on one or more exterior surfaces of the structural component, as shown in FIG. 7. In some embodiments, one or more lines 226 are plated, coated, printed, or otherwise formed on the external surface 260 of a conventional structure component 222. For example, the lines 226 can be formed as electrical lines by alternating dielectric and conductive material. In some embodiments, the dielectric material can be any suitable ceramic or plastic, including but not limited to ABS, nylon, polyetheretherketone (PEEK), polyetherimide (e.g., Ultem®), alumina, silica, etc., and the conductive material can include, for example, copper, gold, silver, and/or aluminum, to name a few.

According to aspects of the present disclosure, any structural component, or part thereof, can be fabricated by additive manufacturing (AM) techniques. Conventionally, the structural components have been heretofore fabricated by traditional metal fabrication techniques, such as CNC machining, forging techniques, casting techniques, or metal forming techniques. In one aspect of the present disclosure, an alternative fabrication technique or methodology is provided wherein the structural component is fabricated layer by layer via the process of, for example, direct metal laser sintering (DMLS), selective laser sintering (SLS), selective laser melting (SLM®), electron Beam Melting (EBM), electron beam freeform fabrication (EBMM), sometimes referred to as electron beam additive manufacturing (EBAM®), fused filament fabrication (FFF), sometimes referred to as fused deposition modeling (FDM®), or a similar form of additive manufacturing, depending, for example, on material selection, desired properties of the finished part, the part's intended application, etc. Embodiments of these components parts can be fabricated as described below. Other embodiments of the component parts can be fabricated with any conventional process, such as extrusion, forging, casting, metal forming, etc.

With the use of additive manufacturing techniques and methodologies in some embodiments, the designer of the structural component has a large degree of flexibility in the orientation, placement, and shape of the passageways/lines (e.g., transmission lines). For example, a number of small passageways can be placed side-by-side instead of a single large passageway. Additionally, the placement of the embedded transmission lines can be designed such that they avoid high stress areas of the structural component and has easily accessible inlets/outlets.

In some embodiments of the present disclosure, the structural components 20, 120, 220, or parts thereof, are fabricated out of metal, thermoplastic, etc., in an additive manufacturing technique. Additive manufacturing is a type of three-dimensional (3D) printing where material is solidified in a pattern controlled by computer-aided design (CAD) instructions, and the part being produced is built on a layer-by-layer basis. Unlike a conventional machining process, where material is removed from stock to produce a part, additive manufacturing builds the part by adding layers, where each layer is solidified by a computer-controlled source, such as a laser or an electron-beam, before the tray or bed moves incrementally to allow a new layer to be solidified adjacent the previous layer, or by adding solid stock material directly. Additive manufacturing is capable of producing parts from a wide variety of materials, including metals, polymers, and minerals.

One type of additive manufacturing, powder bed fusion (e.g., selective laser sintering (SLS), selective laser melting (SLM®), etc.), can be used to fabricate the structural components. The powder bed fusion technique uses a high power-density laser, or an electron-beam, to melt and infuse a metallic powder into a solid. A wide variety of alloys are compatible with the powder bed fusion technique. To start the process, a 3D CAD model is broken into layers, typically on the order of 10 to 100 μm thick, and each layer is converted to a two-dimensional (2D) image for processing. During the additive manufacturing of the powder bed fusion technique, a thin layer of metal powder is applied to an operating plate or bed, and the laser traces the 2D image of a layer, melting and fusing the powdered metal together into the shape of the layer dictated by the CAD data. Then, the plate lowers by the thickness of a layer and the recently printed layer is covered by another thin layer of the metal powder and the laser traces the next image of a layer, melting and fusing the powdered metal together into the shape of the new layer and to the previously printed layer.

In other embodiments, the structural components 20, 120, 220, or parts thereof, can be fabricated out of metal wire using EBM or EBAM®. Differing from the SLS process, direct deposition, such as EBM or EBAM® uses a wire feed for producing complex metal parts with a heat source, (e.g., electron-beam) to generate heat and melt a solid metal stock (e.g., wire or rod) into a part. The direct deposition process creates parts in an additive manner, directly depositing a solid metal stock. The direct deposition process is able to produce metal parts with strength approximately equivalent to forged metal parts.

In some embodiments of the present disclosure, the structural components 20, 120, 220, or parts thereof, can be fabricated out of thermoplastic, employing fused filament fabrication (FFF) techniques, such as fused deposition modeling (FDM®). Generally described, FDM® techniques employ a fused deposition modeling system or the like to build a 3D part or model from a digital representation of the 3D part in a layer-by-layer manner by extruding a flowable part material. The part material is extruded through an extrusion tip carried by an extrusion head, and is deposited as a sequence of paths, or “roads,” on a substrate in an x-y plane. The extruded part material fuses to previously deposited modeling material, and solidifies upon a drop in temperature. The position of the extrusion head relative to the substrate is then incremented along a z-axis (perpendicular to the x-y plane), and the process is then repeated to form a 3D part resembling the digital representation.

Movement of the extrusion head with respect to the substrate is performed under computer control, in accordance with build data that represents the 3D part. The build data is obtained by initially slicing the digital representation of the 3D part into multiple horizontally sliced layers. Then, for each sliced layer, the host computer generates a build path for depositing roads of modeling material to form the 3D part.

Of course, in some embodiments, a combination of two or more additive manufacturing techniques briefly described above can be employed to fabricate the structure components with one or more embedded passageways or lines or one or more externally formed passageways or lines. After fabrication, other post-machining or post-processing steps can be carried out.

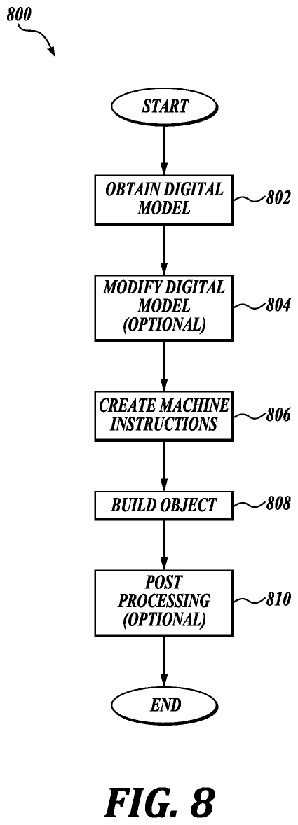

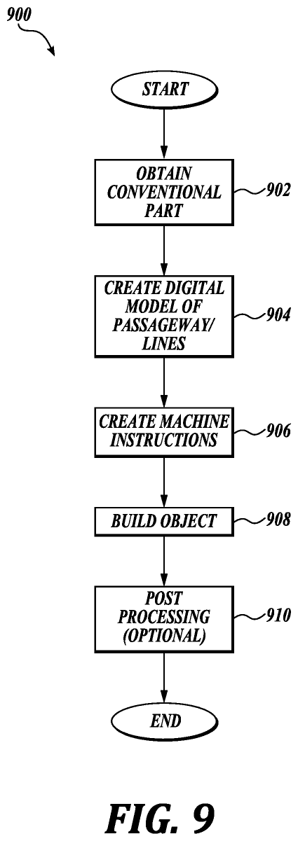

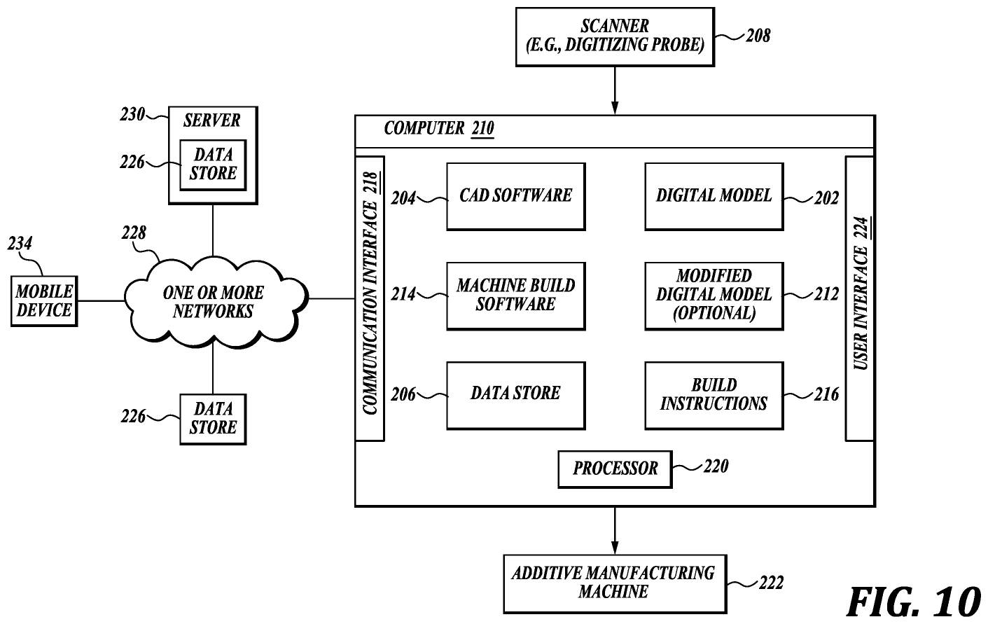

FIG. 8 is a block diagram illustrating a representative fabrication process of a component part having a plurality of lines, such as structural component 20. FIG. 9 is a block diagram illustrating a representative fabrication process of a component part having a plurality of lines, such as structural component 120 and/or 220. FIG. 10 is a block diagram depicting one environment, including one or more components of a system, used to carry out the one or more processes of the methods set forth in FIG. 8 or FIG. 9.

As can be seen in FIG. 8, the first step in the process is obtaining, at block 802, a digital model 202 (see FIG. 10), such as a Computer Aided Design (CAD) solid model or CAD surface model, of an object to be fabricated, such as structural component 20. In some embodiments, the digital model includes graphical 2D or 3D data representing the object to be fabricated.

The digital model 202 at block 802 may be obtained in a number of ways. For example, the digital model 202 may be obtained by generating a solid model of the structural component and/or surface model of the inner surfaces of the passageways within CAD software 204 (see FIG. 9). In other embodiments, the digital model 202 may be obtained from a data store, such as data store 206 of the computer 210, which stores one or more CAD models of component parts, such as structural components, for various applications, such as landing gear for a BOEING® 737, BOEING® 777, BOEING® 787, AIRBUS® 320, AIRBUS® 330, BOMBARDIER® Global 7500 aircraft, EMBRAER® E195, just to name a few. It will be appreciated that the digital model 202 may be obtained from other data stores, such as a data store 226 associated with either a local or remote server 230 or cloud based storage solution. Such communication with these data stores 226 is facilitated by communications interface 218 through one or more networks 228.

In other embodiments, the digital model 202 may be obtained by scanning a previously fabricated component part, a prototype of the component part made from clay modeling, etc., and inputting the scanned data into a suitable CAD program, such as CAD software 204. For example, a component part may be scanned (e.g., measured) using a digitizing probe 208 that traverses the surfaces of the object to generate suitable 2 and 3 dimensional data indicative of the geometry thereof.

In yet other embodiments, the digital model 202 can be created in a CAD system with the use of computer 210 and CAD software 204. The design can be general to very detailed, but generally includes design details such as external shape and size of the part, internal passage size and location, cross-sectional shape along the structural component, and the like. In some embodiments, the digital model includes graphical data representative of the structural component 20, structural component 120, structural component 220, etc., or parts thereof.

Once the digital model 202 of the component part is obtained, the method 800 continues to block 804, where the digital model 202 can be viewed and optionally manipulated by the computer 210 within CAD software 204. For example, at block 204, the CAD technician or the like can interactively modify the digital model 202 via the CAD software 204 in order to alter the geometry of one or more portions of the component part, aiming for improved characteristics, modifications for a custom or new installation, etc. In some embodiments, the modified digital model 204 includes graphical data representative of the structural component 20, structural component 120, structural component 220, etc., or parts thereof.

Examples of suitable CAD software that be employed for carrying out aspects of some embodiments of the present disclosure include but are not limited to Solid Works, Pro-E, CATIA, etc. Once obtained and/or modified, the digital model 202 or modified digital model 212 (optional) can be saved, for example, to system memory, such as the data store 206, and/or associated memory, such as data store 226 from a local or remote server 230 or a cloud based storage solution.

Once the CAD design of the part is created, the structural component can then be fabricated, using any additive manufacturing process, such as fused filament fabrication (e.g., fused deposition modeling (FDM®)), stereolithography (SLA), selective laser sintering (SLS), electron beam melting, electron beam additive manufacturing (EBAM®), among others, with an additive manufacturing machine 222.

The additive manufacturing machine 222 is utilized to fabricate the component part in three dimensions on a bed, such as a fixture or fixtureless platform, from a CAD data file, such as the digital model 202 or modified digital model 204. In order for the an additive manufacturing machine 222 to fabricate the component part in some embodiments, the CAD data file, such as the digital model 202 or modified digital model 204, may need to be translated into suitable machine instructions. Accordingly, at block 806 of the method 800, the digital model 202 or modified digital model 204 is processed for compatibility with the manufacturing system, including the additive manufacturing machine 222. In an embodiment of the present disclosure, a surface file (also known as a .stl file) is created from the either the digital model 202 or the modified digital model 204, depending on which is being used to fabricate the component part. The surface file conversion allows the manufacturing system to read CAD data from any one of a variety of CAD systems, such as CAD software 204 running on computer 210. In some embodiments, processing of the CAD data file (e.g., digital model 202, modified digital model, etc.) can be carried out by the computer 210, the additive manufacturing apparatus 222 or a combination of the computer 210 and the additive manufacturing apparatus 222.

It will be appreciated that the CAD data files or surface files may be stored on a computer-readable medium either associated with the CAD system, the manufacturing system or a networked or cloud based storage solution. For example, computer-readable media can be any available media that can be accessed by the computer 210 or the computer 210 and/or the additive manufacturing apparatus 222. By way of example, and not limitation, computer-readable media may comprise computer storage media and communication media. Computer storage media includes volatile and nonvolatile, removable and non-removable media implemented in any method or technology for storage of information such as computer readable instructions, data structures, program modules or other data. In some embodiments, this surface file is then converted into cross-sectional slices or slice files, where each slice can be uniquely defined about its build strategy by varying the tool path, laser beam, bed, tray, etc., of the machine 222.

Once suitable machine instructions are created (if needed), such as the surface and/or slice files, at block 806, these machine instructions are then used by the additive manufacturing machine 222 to build the object or component part at block 810.

In one embodiment, an EBAM® apparatus is used to carry out the machine instructions. With EBAM®, an electron beam is used to melt wire onto a surface to build up a part. With this process, an electron-beam gun provides the energy source used for melting metallic feedstock, which is typically wire. In some embodiments, the desired wire material is selected from a group consisting of titanium, nickel chromium, austenitic nickel chromium (e.g., Inconel®, etc.), stainless steel, just to name a few. Using EBAM®, feedstock material is fed into a molten pool created by the electron beam. Through the use of computer controls, the molten pool is moved about on a substrate plate, adding material where it is needed to produce the object based on the build strategy of the part to be manufactured and represented in the CAD data file. This process is repeated in a layer-by-layer fashion, until the desired 3D object is produced.

In another embodiment, a FDM® apparatus is used to carry out the machine instructions. In this regard, a filament of the desired material passes through a heated liquefier. In some embodiments, the desired material is selected from a group consisting of thermoplastics. In some embodiments, the thermoplastics includes a class of thermoplastics comprising polyetherketoneketone (PEKK), such as Antero 800NA from Stratasys Direct Manufacturing. Other examples of materials that may be used in these embodiments include but are not limited to nylon, ABS, polyetherimide (e.g., Ultem®), thermoplastic polyurethane (TPU). Of course, other materials may be used.

The liquefier melts the material and extrudes a continuous bead, or road, of material through an extrusion tip carried by an extrusion head and deposits the material on a fixtureless platform. The extrusion head is computer controlled along the X and Y directions, based on the build strategy of the part to be manufactured and represented in the CAD data file. When deposition of the first layer is completed, the fixtureless platform indexes down, and the second layer is built on top of the first layer. This process continues in computer control until the part manufacturing is completed.

After the object, such as the component or component part, is built at block 808, one or more post processing steps can be optionally carried out at block 810. For example, the passageways of the structural components or other surfaces can be deburred or otherwise smoothed, as needed. In some embodiments in which the structural component is fabricated out of thermoplastic, the object may be plated or otherwise coated with a conductive or magnetic material. In one embodiment, one or more external surfaces of the component or component part, such as structural component 20, is plated or coated, for example, with nickel, zinc or copper.

In embodiments that manufacture the component or component part out of metal, nickel, zinc or copper plating or coatings may be applied in some embodiments and omitted in others. In these or other embodiments, the post processing steps can additionally or alternatively include plating or otherwise coating one or more of the passageways of the structural component 20 with an anti-friction material, such as PTFE. In some embodiments, the anti-friction coating can be subsequently applied via suitable processes onto the metal plating or coating.

FIG. 9 is a block diagram illustrating another representative fabrication process of a structural component, of part thereof, having a plurality of passageways, electrical lines, etc., such as structural components 120 and/or 220. As can be seen in FIG. 9, the first step in the process is obtaining, at block 902, a conventional structural component without passageways or lines. Examples of some structural components that can be obtained include but are not limited to landing gear structural components, such as a shock strut, trailing arms, a truck beam, side or drag braces, etc., for a BOEING® 737, BOEING® 777, BOEING® 787, AIRBUS® 320, AIRBUS® 330, BOMBARDIER® Global 7500, EMBRAER® E195, just to name a few.

Next, at block 904, a digital model 202 (see FIG. 10), such as a Computer Aided Design (CAD) solid model or CAD surface model, of the passageways/lines, such as passageways/lines 126 and/or 226 to be formed onto the obtained conventional structural component is created. In some embodiments, the digital model includes graphical 2D or 3D data representing the object to be fabricated. For example, the digital model 202 may be created by generating a solid model of the passageways/lines, such as passageways/lines 126 and/or 226, to be formed onto the obtained conventional structural component within CAD software 204 (see FIG. 9). The design can be general to very detailed, but generally includes design details such as external shape and size of the part, line/passageway sizes and location, cross-sectional shape, etc., and/or the like. In some passageways/lines, the digital model includes graphical data representative of the passageways/lines 126 and/or 226.

Once obtained and/or modified (optional), the digital model 202 or modified digital model 212 (optional) can be saved, for example, to system memory, such as the data store 206, and/or associated memory, such as data store 226 from a local or remote server 230 or a cloud based storage solution.

Once the CAD design is created, the object, such as structural component 120 and/or 220, can then be fabricated with the use of any suitable additive manufacturing process, such as fused deposition modeling (FDM), stereolithography (SLA), selective laser sintering (SLS), electron beam additive manufacturing (EBAM®), among others, with an additive manufacturing machine 222.

The additive manufacturing machine 222 is utilized to fabricate in three dimensions the passageways/lines 126 and/or 226 onto the external surface of the conventional structural component from a CAD data file, such as the digital model 202 or modified digital model 212. In order for the additive manufacturing machine 222 to fabricate the component part in some embodiments, the CAD data file, such as the digital model 202 or modified digital model 212, may need to be translated into suitable machine instructions. Accordingly, at block 906 of the method 900, the digital model 202 or modified digital model 212 is processed for compatibility with the manufacturing system, including the additive manufacturing machine 222. Similar processing, for example, has been described above with reference to block 806.

Once suitable machine instructions are created (if needed), such as the surface and/or slice files, at block 906, these machine instructions are then used by one or more additive manufacturing machines 222 to build the passageways and/or electrical lines onto the exterior surface of a conventional structural component at block 908. It will be appreciated that the type of AM technique will depend on the intended structure (passageways, electrical lines, etc.,) to be fabricated. Optional post processing/machining can be carried out at block 910.

As described above, one or more aspects of the methods set forth herein are carried out in a computer system. In this regard, a program element is provided, which is configured and arranged when executed on a computer for fabricating the component part, such as the structural component 20, the structural component 120, the structural component 220, or parts thereof. In one embodiment, the program element may specifically be configured to perform the steps of: obtaining digital data representative of one or more transmission lines; and using the digital data to fabricate the structural component at least in part by a solid freeform fabrication process.

The program element may be installed in a computer readable storage medium. The computer readable storage medium may be any one of the computing devices, control units, etc., described elsewhere herein or another and separate computing device, control unit, etc., as may be desirable. The computer readable storage medium and the program element, which may comprise computer-readable program code portions embodied therein, may further be contained within a non-transitory computer program product.

As mentioned, various embodiments of the present disclosure may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above. In some embodiments, the data store 206 and/or data store(s) 226 can comprise one or more of the computer readable storage media.

As should be appreciated, various embodiments of the present disclosure may also be implemented as methods, apparatus, systems, computing devices, computing entities, and/or the like, as have been described elsewhere herein. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Various embodiments are described above with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

In some embodiments, one such special purpose computer includes computer 210. Computer 210 includes a processor 220 configured to executed program code, such as the CAD software 204 and/or machine build software 214. While a single processor can be employed, as one of ordinary skill in the art will recognize, the computer 210 and/or additive manufacturing machine 222 may comprise multiple processors operating in conjunction with one another to perform the functionality described herein. In addition to the memory (e.g., computer readable storage media), which is implemented in some embodiments as data store 206, the processor 220 can also be connected to at least one interface or other means for displaying, transmitting and/or receiving data, content or the like. In this regard, the interface(s) can include at least one communication interface 218 or other means for transmitting and/or receiving data, content or the like, as well as at least one user interface 224 that can include a display and/or a user input interface. The user input interface, in turn, can comprise any of a number of devices allowing the entity to receive data from a user, such as a keypad, a touch display, a joystick or other input device.

The communication interface 218 in some embodiments is configured to transmit and/or receive data, content or the like from other devices via one or more networks 228. According to various embodiments, the one or more networks 228 may be capable of supporting communication in accordance with any one or more of a number of cellular protocols, including second-generation (2G), 2.5G, third-generation (3G), fourth-generation (4G) mobile communication protocols, or the like, as well as other techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like. Although the computer 210, the server 230, and the mobile device 234 are illustrated in FIG. 10 as communicating with one another over the same network, these devices may likewise communicate over multiple, separate networks.

According to various embodiments, many individual steps of a process may or may not be carried out utilizing the computer systems and/or servers described herein, and the degree of computer implementation may vary, as may be desirable and/or beneficial for one or more particular applications.

Some embodiments of the present disclosure may reference components or component parts suitable for use in aircraft. However, it will be appreciated that aspects of the present disclosure transcend any particular vehicle type or industry, and any reference to aircraft or the like is only representative, and therefore, should not be construed as limiting the scope of the claimed subject matter.

The present application may include references to directions, such as “forward,” “rearward,” “front,” “rear,” “upward,” “downward,” “top,” “bottom,” “right hand,” “left hand,” “lateral,” “medial,” “distal,” “proximal,” “in,” “out,” “extended,” etc. These references, and other similar references in the present application, are only to assist in helping describe and to understand the particular embodiment and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A solid freeform fabricated structure component, comprising:
a body having a first end and a second end;
one or more passageways extending through at least a section of the body; and
at least one attachment interface positioned near the first end.

2. The structural component of claim 1, wherein the body has a plurality of exterior surfaces, wherein at least one of the exterior surfaces is constructed of or plated with a metal material.

3. The structural component of claim 1, wherein the one or more passageways define a plurality of interior surfaces, wherein at least one of the interior surfaces is constructed of or plated with an anti-fiction coating.

4. The structural component of claim 3, wherein the body includes an integral attachment interface at the second end.

5. The structural component of claim 1, further comprising at least one electrical wire routed through one passageway of the one or more passageways.

6. The structural component of claim 5, wherein the at least one electrical wire is selected from a group consisting of a power wire configured to carry a power signal, a sensor wire configured to carry a sensed signal, and a control wire configured to carry a control signal.

7. The structural component of claim 6, wherein the one or more passageways includes two or more passageways, and wherein the at least one electrical wire is two or more electrical wires routed through respective passageways of the two or more passageways.

8. The structural component of claim 6, wherein:
the one or more passageways includes more than two passageways;
the at least one electrical wire is two electrical wires routed through two passageways, respectively, of the more than two passageways; and
any remaining passageways is adapted to be connected to a source of pressurized fluid.

9. The structural component of claim 1, wherein the one or more passageways is connected to a manifold at each end of the passageway, wherein at least one manifold is configured to connect to a source of pressurized fluid.

10. A method of making a structural component having one or more transmission lines, comprising:
obtaining digital data representative of the one or more transmission lines;
using the digital data to fabricate the structural component at least in part by a solid freeform fabrication process.

11. The method of claim 10, wherein the solid freeform fabrication process is selected from the group consisting of direct metal laser sintering (DMLS), selective laser sintering (SLS), electron beam melting (EBM), electron beam freeform fabrication (EBMM), and fused filament fabrication.

12. The method of claim 10, wherein the one or more transmission lines includes a plurality of transmission lines, and wherein the plurality of transmission lines includes at least two pressurized fluid transmission lines.

13. The method of claim 12, further comprising
routing an electrical transmission wire through at least one of the plurality of transmission lines.

14. The method of claim 10, wherein the one or more transmission lines include at least one electrical signal transmission line.

15. The method of claim 14, wherein the at least one electrical signal transmission line is formed layer by layer onto an exterior surface of a base component.

16. The method of claim 15, wherein the electrical signal transmission line is formed layer by layer onto an exterior surface of a base component with a dielectric material and a conductive material.

17. The method of claim 10, further comprising
obtaining digital data representative of a body that include the one or more transmission lines located within the body;

18. The method of claim 17, further comprising plating at least one of the transmission lines with an anti-friction coating.

19. The method of claim 10, wherein the digital data is further representative of at least one attachment structure.

20. A computer readable medium having a computer executable component comprising CAD data to enable the fabrication of structural component having one or more transmission lines utilizing a solid freeform fabrication process.
